(19) United States
(12) Patent Application Publication
(10) Pub. No.: US 2004/0154556 A1
(43) Pub. Date: Aug. 12, 2004

(54) Pet collar leash device

(76) Inventors: Steve Masterson, Deerfield Beach, FL (US); Susan Giddens, Gower, MO (US)

Correspondence Address: STINSON MORRISON HECKER LLP, ATTN: PATENT GROUP, 1201 WALNUT STREET, SUITE 2800, KANSAS CITY, MO, 64106-2150, US

(21) Appl. No.: 10/625,148

(22) Filed: Jul. 23, 2003

Related U.S. Application Data
(60) Provisional application No. 60/399,328, filed on Jul. 23, 2002.

(51) Int. Cl. A01K 27/00

(52) U.S. Cl. 119/794

(57) ABSTRACT

The present invention is directed to a pet collar leash device adapted to be attached to and be carried on a pet collar. The collar leash device comprises a leash and a housing for receiving and storing the leash, wherein the housing is adapted to attach to and be carried on the pet's collar during and between uses of the leash. The pet end of the leash is secured within the housing, and the user end of the leash extends out of the housing and is accessible to the user. The collar leash device preferably possesses a handle attached to the user end of the leash for the user to hold when walking the pet. Preferably the housing is configured to receive and store the handle when the leash is not in use.

### CROSS-REFERENCE TO RELATED APPLICATIONS

This application is based on U.S. Provisional Application Serial No. 60/399,328, filed on Jul. 23, 2002, which is hereby incorporated herein by reference.

### STATEMENT REGARDING FEDERALLY SPONSORED RESEARCH OR DEVELOPMENT

Not Applicable.

### BACKGROUND OF THE INVENTION

1. Field of the Invention

The present invention is related to the field of pet products. More specifically, the invention is directed to a pet collar leash device adapted to be attached to and carried on a pet collar.

2. Description of Related Art

Pet ownership is prevalent in the United States and around the world. There are over 130 million pets in the United States alone. Many pet owners, particularly dog owners, walk their pets for recreation and/or to allow the pet to relieve itself. There are a large number of pet leashes available to pet owners, including a variety of retractable leash devices. However, once purchased, the leash is easily misplaced and is often not readily available when the pet owner desires to take the pet for a walk.

### BRIEF SUMMARY OF THE INVENTION

The present invention is directed to a pet collar leash device adapted to be attached to and carried on a pet collar. The collar leash device comprises a leash and a housing for receiving and storing the leash, wherein the housing is adapted to attach to the pet's collar. Unlike prior leash devices in which the housing is carried by the user and the device is removed after use of the leash, the housing of the collar leash device of the present invention is carried on the pet collar during and between uses of the leash. A first end of the leash is secured within the housing of the collar leash device attached to the pet. The second user end of the leash extends from the housing and is accessible to the user. The user simply pulls the user end of the leash to extend the leash from the housing of the collar leash device whenever the user desires to use the leash.

The collar leash device preferably possesses a handle attached to the user end of the leash for the user to hold when walking the pet. Preferably the housing is configured to receive and store the handle when the leash is not in use. The leash is preferably retractable, such that it retracts into the housing when not in use. A brake is preferably employed to allow the user to fix the leash in an extended position.

The collar leash device of the present invention may easily be attached to a pet collar for permanent, semi-permanent or temporary attachment. The collar leash device is conveniently carried on the pet's collar such that it is readily available when the user is ready to take the pet for a walk. Rather than having to retrieve or look for the leash, the user can simply reach down and pull the user end of the leash from the collar leash device carried on the pet's collar.

### BRIEF DESCRIPTION OF THE DRAWINGS

FIG. 1 is a pictorial view of a first embodiment of the collar leash device of the present invention attached to a collar and fastened on a pet.

FIG. 2 is a side plan view of the collar leash device of FIG. 1.

FIG. 3 is a cross-sectional view of the collar leash device of FIG. 2, taken along line 3-3 of FIG. 2.

FIG. 4 is a cross-sectional view of the collar leash device of FIG. 3, taken along line 4-4 of FIG. 3.

FIG. 5 is a cross-sectional view of a second embodiment of the collar leash device of the present invention.

### DETAILED DESCRIPTION OF PREFERRED EMBODIMENT

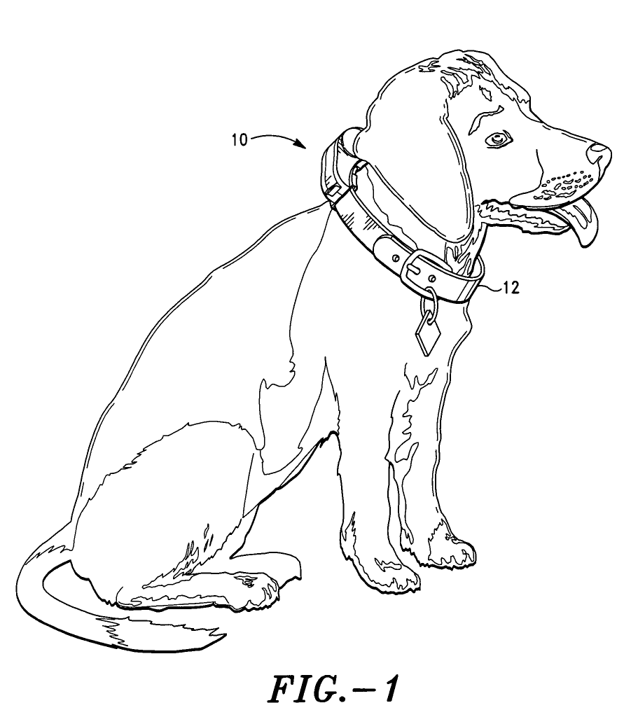

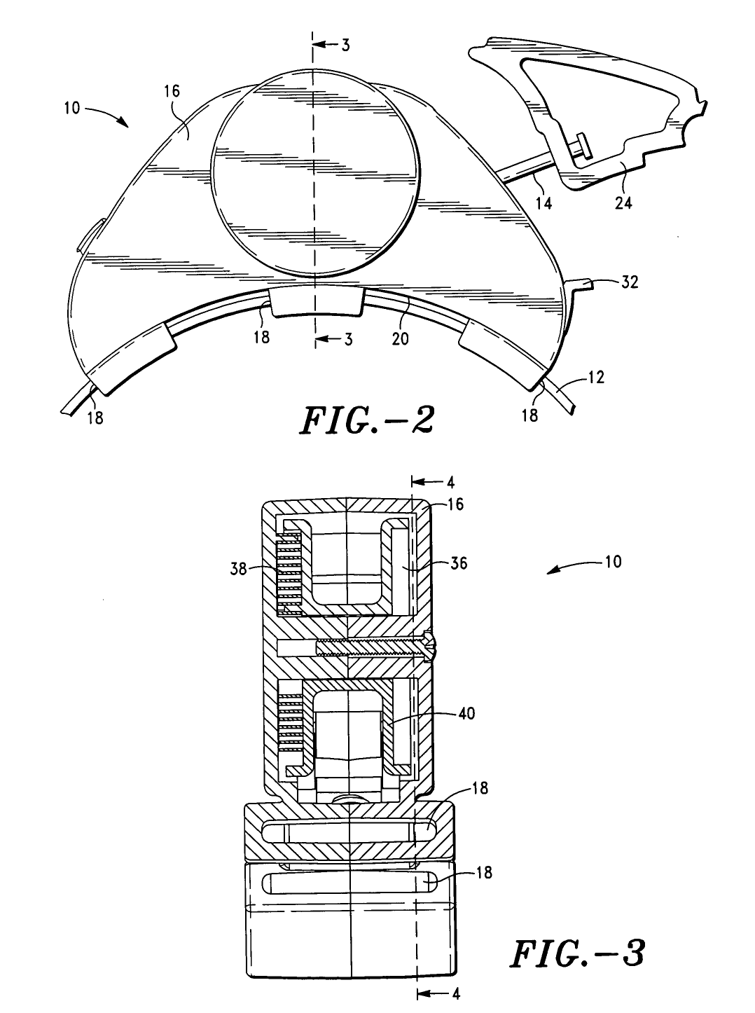

Turning to FIG. 1, the present invention is directed to a collar leash device 10 adapted to attach to and be carried on pet collar 12. As depicted in FIG. 2, collar leash device 10 comprises leash 14 and housing 16 adapted to attach to and be carried on pet collar 12 during and between uses of the leash. Thus, collar leash device 10 permits the user to always have a leash available, thereby avoiding the necessity of having to locate a leash when it is time to walk the pet.

Housing 16 of the present invention is adapted to be carried on collar 12 both during and between uses of the leash. Thus, housing 16 is preferably adapted to attach to collar 12 in a manner that will not interfere with the pet's legs and or catch on objects, such that collar leash device 10 may safely be left on the pet between uses of the leash. Furthermore, housing 16 preferably is adapted to attach to collar 12 securely, in a manner that is not readily removable by the pet. Any device for securely attaching housing 16 to collar 12 that allows housing 16 to be carried on collar 12 during and between uses of the leash, without interfering with the pet's legs, may be employed, including holes, slots, snaps, hooks, short straps, glue, rivets, screws, bolts or other attachment devices known in the art or hereafter developed. It should be understood that a housing 16 having an attachment device either formed integrally with, or affixed to, housing 16 shall be considered to be a housing adapted to attach to and/or be carried on collar 12.

Preferably, housing 16 is adapted to be attached to collar 12 in a manner that stabilizes and secures collar leash device 10 against collar 12. In the preferred embodiment, housing 16 is configured with at least one collar slot 18 for receiving a collar 12, as depicted in FIGS. 2 and 3. More preferably, housing 16 is configured with multiple collar slots 18, or a single long collar slot 18. Preferably the base 20 of housing 16 is inwardly curved to generally conform to the shape of the pet's neck to increase the stability of housing 16 against collar 12. Collar slots 18 may be formed integrally with housing 16 or may be affixed to housing 16 using any means known in the art or hereafter developed.

Housing 16 may be adapted to be removably attached to collar 12, such as by snaps, wherein housing 16 may be removed from collar 12 by the user without removing collar 12 from the pet. Preferably housing 16 is adapted to be semi-permanently attached to collar 12, such as by collar slots 18, wherein housing 16 may only be removed from collar 12 when collar 12 is removed from the pet. In an alternative embodiment, housing 16 is adapted to be permanently attached to collar 12, such as by rivets, wherein housing 16 may not be readily removed from collar 12, even when collar 12 is removed from the pet.

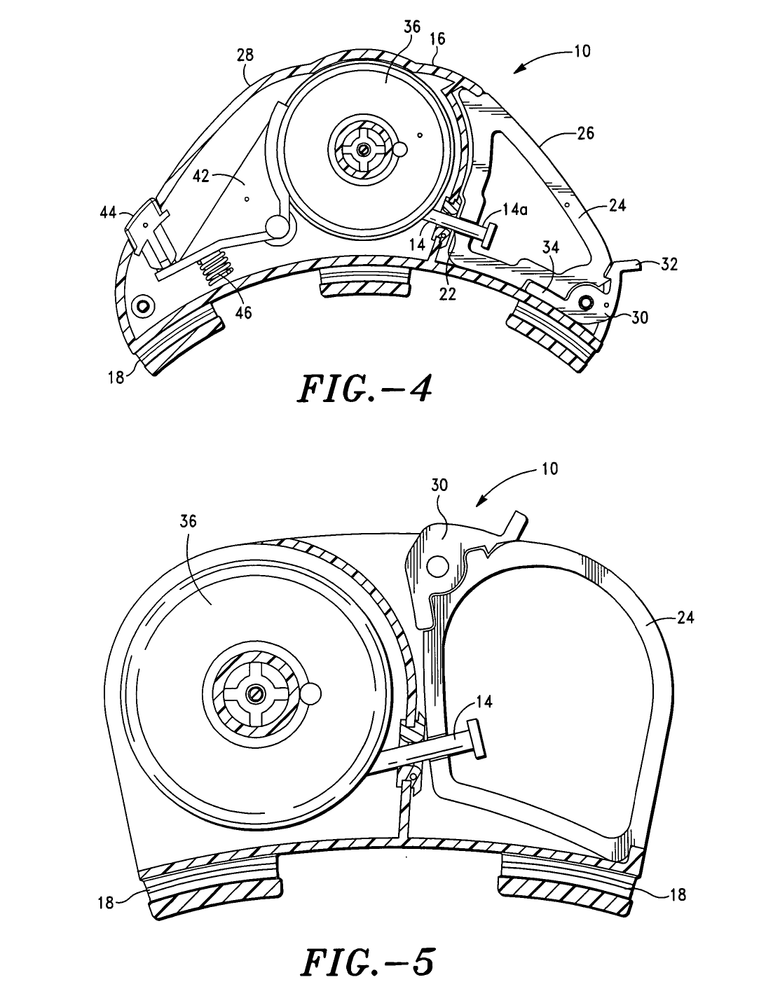

Housing 16 may be any structure capable of receiving and storing leash 14. Leash 14 comprises a first pet end, which is attached to and carried on the pet during use of the leash, and a second user end, which is held by the user during use of the leash. The first pet end of leash 14 is secured in place within housing 16 by any means known in the art or hereafter developed. The second user end 14a of leash 14 is accessible to the user, as depicted in FIG. 4. Unlike prior leash devices wherein the user end of the leash is enclosed within the housing, in the present invention, user end 14a of leash 14 extends out of housing 16 and may be grasped by the user separately from the housing. Preferably user end 14a of leash 14 extends through leash slot 22 in housing 16, as depicted in FIG. 4.

In a first stored position, leash 14 is substantially enclosed within housing 16, with user end 14a extending from housing 16. In a second extended position, leash 14 is extended from housing 16 a sufficient distance to allow a user to walk the pet. Thus, the second extended position refers to any of a variety of positions wherein leash 14 is extended a sufficient distance to allow a user to walk the pet.

Preferably user end 14a of leash 14 terminates in handle 24. Handle 24 may be formed any shape, but is preferably formed in a shape that allows easy gripping by the user. In one preferred embodiment, handle 24 is shaped in the form of an animal or animal related item, such as a dog bone. In a second preferred embodiment, handle 24 and housing 16 are configured such that handle 24 may be received and stored within housing 16 when the leash is not in use, as depicted in FIG. 4. In such embodiment, the outer edge 26 of handle 24 is preferably formed to correspond to the shape of the outer edge 28 of housing 16. In the embodiment depicted in FIG. 4, handle 24 is retained in place within housing 16 by handle latch 30. Preferably, handle latch 30 is pivotally affixed to housing 16, such that when latch tip 32 of handle latch 30 is depressed by the user, handle latch 30 pivots, causing latch arm 34 of handle latch 30 to press against handle 24 and dislodge handle 24 from housing 16. Thus, handle 24 and user end 14a of leash 14 remain accessible to the user. Furthermore, although handle 24 and user end 14a of leash 14 can be stored within housing 16, user end 14a is still considered to extend out of housing 16, in that it extends out of the body of housing 16 and can be grasped and pulled out of housing 16 by the user.

Preferably the first pet end of leash 14 is secured to and wound around a spool apparatus 36 within housing 16. More preferably leash 14 is a retractable leash and spool apparatus 36 is spring biased to retract leash 14 into housing 16 and around spool apparatus 36 in the absence of an external force. A preferred spool apparatus 36, comprising spring 38 and spool 40, is depicted in FIG. 3. However, any spool apparatus or other device for retracting leash 14 known in the art or developed in the future may be used consistent with the present invention. Alternatively, leash 14 may be folded, coiled, rolled or arranged in any other configuration that can be contained within housing 16. Spool apparatus 36 may be comprised of any suitable material, and is preferably comprised of the same material as housing 16. Spring 38 is preferably made from a corrosion-resistant metallic alloy that has a high tensile strength, yet can be flexed in response to external pressure on the leash.

Returning to FIG. 4, collar leash device preferably includes a brake 42 to inhibit leash 14 from extending from or retracting into housing 16. A suitable brake system comprising brake 42, release button 44 and brake spring 46 is depicted in FIG. 3. In such embodiment, brake 42 is pivotally affixed within housing 16, such that brake 42 pivots between a first braking position and a second release position. In the first braking position, depicted in FIG. 3, brake 42 engages spool apparatus 36 to inhibit leash 14 from extending or retracting. To release brake 42, the user depresses release button 44, thereby moving brake 42 to the second release position. In the second release position, brake 42 disengages spool apparatus 36, such that leash 14 is allowed to extend in the presence of an external force or retract in the absence of an external force. When the force depressing release button 44 is removed, brake spring 46 recoils to return brake 42 to the first braking position. In an alternative embodiment, release button is a lock button that maintains the brake in a locked position when depressed and allows the brake to return to the release position when released. In either embodiment, a trigger may be employed to retain the release button or lock button in the depressed position. Various other brake mechanisms known in the art or hereafter developed may be employed consistent with the present invention, as will be apparent to one in the art. Alternatively, collar leash device 10 may not include a brake system, as depicted in FIG. 5.

Housing 16 may be formed in any shape capable of receiving and storing leash 14. Housing 16 is preferably comprised of a material selected from the group consisting of aluminum, plastic, such as polyvinyl chloride or nylon plastic, and stainless steel, although any other suitable materials may be used, as can be readily determined by one in the art. Collar 12 may be any pet collar, and may be made from a variety of materials, including leather, braided metal or nylon plastic. Leash 14 may be made from a variety of materials, including braided nylon or polypropylene.

In one embodiment of the present invention, housing 16 can function as jewelry and be configured in an aesthetically pleasing shape, such as a dog bone. In another embodiment of the present invention, housing 16 may be engraved, printed or otherwise marked with the animal's identification information. The identification information may be applied directly to housing 16, or an identification plate for receiving such information may be affixed to the exterior of housing 16.

To install collar leash device 10, housing 16 is attached to pet collar 12. In the preferred embodiment, collar leash device 10 is installed by inserting collar 12 through collar slots 18. Collar 12 is then fastened around the neck or other part of the pet. It should be understood that when housing 16 is adapted to be removably attached to collar 12, collar leash device 10 may be attached to pet collar 12 prior to or after fastening collar 12 on the pet. The user may then grasp and pull second user end 14a of leash 14, using handle 24 if present, to extend leash 14 from housing 16 whenever leash 14 is desired or needed. In the preferred embodiment wherein handle 24 is stored within housing 16 when the leash is not in use, to access handle 24, the user depresses latch tip 32 of handle latch 30 to dislodge handle 24 from housing 16. In the embodiment of the present invention employing a brake system, the user then depresses release button 44, pulls handle 24 until the desired length of leash 14 is extended from housing 16, and releases release button 44 to lock brake 42 and prevent leash 14 from further extending from or retracting into housing 16. When the user is finished using leash 14, the user depresses release button 44 to release brake 42 and allow leash 14 to retract into housing 16. When leash 14 is fully retracted into housing 16, the user fits handle 24 into housing 16, under handle latch 30, and releases release button 44 to lock leash 14 in place within housing 16. The user does not need to detach collar leash device 10 from the pet's collar, and the leash remains with the pet.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

What is claimed and desired to be secured by Letters Patent is as follows:

1. A collar leash device, comprising:
a leash having a first pet end and a second user end; and
a housing configured to receive and store said leash,
wherein said first pet end of said leash is secured within said housing and said second user end is accessible to a user, and
wherein said housing is adapted to be carried on a pet collar during and between uses of said leash.

2. The device as claimed in claim 1, further comprising a handle connected to said user end of said leash, wherein said housing is configured to receive and hold said handle.

3. The device as claimed in claim 2, further comprising a handle latch for retaining said handle within said housing.

4. The device as claimed in claim 1, wherein said leash is retractable.

5. The device as claimed in claim 4, further comprising a spring-biased spool apparatus for retracting said leash into said housing.

6. The device as claimed in claim 5, further comprising a brake for inhibiting extension and retraction of said leash.

7. The device as claimed in claim 1, wherein said housing comprises at least one collar slot for receiving the collar.

8. The device as claimed in claim 7, wherein said housing comprises at least three collar slots.

9. The device as claimed in claim 7, wherein said collar slot is formed integrally with said housing.

10. The device as claimed in claim 1, further comprising identification information applied to the exterior of said housing.

11. A method for using the device as claimed in claim 1, comprising the steps of:
attaching said housing to the collar;
fastening the collar around the neck of a pet; and
leaving the device attached to the collar and the collar fastened around the neck of the pet between uses of said leash,
wherein said leash is in a first stored position during said leaving step.

12. The method of claim 11, further comprising after said fastening step, the steps of:
grasping said user end of said leash;
pulling said user end of said leash to extend said leash from said first stored position to a second extended position;
walking the pet; and
returning said leash to said first stored position,
wherein said housing is carried on the collar during said walking step.

13. A collar leash device, comprising:
a leash having a first pet end and a second user end; and
a housing configured to receive and store said leash,
wherein said first pet end of said leash is secured within said housing and said second user end is accessible to a user, and
a collar,
wherein said housing is attached to said collar.

14. The device as claimed in claim 13, wherein said housing is semi-permanently attached to said collar.

15. The device as claimed in claim 14, wherein said housing comprises at least one collar slot and said collar is received within said collar slot.

16. The device as claimed in claim 13, wherein said housing is permanently attached to said collar.

17. A collar leash device, comprising:
a leash having a first pet end and a second user end; and
a housing configured to receive and store said leash, wherein said pet end of said leash is secured within said housing and said user end is accessible to a user; and
a means for attaching said housing to a collar and retaining said housing on the collar during and between uses of said leash.

18. The device as claimed in claim 17, further comprising a handle connected to said user end of said leash.

19. The device as claimed in claim 18, wherein said housing is configured to receive and hold said handle.

20. A collar leash device, comprising:
a retractable leash having a first pet end and a second user end;
a housing configured to receive and store said leash, wherein said pet end of said leash is secured within said housing and said user end is accessible to a user; and
a handle connected to said user end of said leash,
wherein said housing is adapted to be carried on a collar during and between uses of said leash.
